(19) United States
(12) Patent Application Publication
(10) Pub. No.: US 2025/0102331 A1
(43) Pub. Date: Mar. 27, 2025

(54) MEASUREMENT DEVICE AND MEASUREMENT METHOD

(71) Applicant: RISE Research Institutes of Sweden AB, Borås (SE)

(72) Inventor: Walter MARGULIS, Leblon – Rio de Janeiro (BR)

(73) Assignee: RISE Research Institutes of Sweden AB, Borås (SE)

(21) Appl. No.: 18/832,176

(22) PCT Filed: Feb. 3, 2023
(86) PCT No.: PCT/EP2023/052743

§ 371 Date: Jul. 23, 2024

(30) Foreign Application Priority Data
Feb. 7, 2022 (EP) 22155410.8

(51) Int. Cl. G01D 5/353; G01D 11/24; G01K 11/3206; G01L 1/24

(52) U.S. Cl. CPC G01D 5/35316; G01D 11/24; G01K 11/3206; G01L 1/246

(57) ABSTRACT

The present disclosure relates to a measurement device (1) for measuring a local parameter using an optical fiber element incorporating an array (100) of fiber Bragg gratings, FBGs, (101, 102, 103, 104), the measurement device (1) comprising: a semiconductor optical amplifier, SOA, (10), wherein the measurement device (1) is configured to be able to cause lasing at a respective lasing wavelength of said FBG (101, 102, 103, 104) of the FBG array (100); wherein the measurement device (1) further comprising: a filter element (40) configured with a wavelength dependent transmission coefficient; an output light sensing element (50) configured to detect said intensity of filtered light pulses from the filter element (40) and emit a corresponding electrical signal; processing means (60) for converting the electrical signal to the local parameter being measured for said one of the FBGs (101, 102, 103, 104) of the FBG array (100), and for providing the local parameter being measured. A measurement method (S100) is also disclosed.

### TECHNICAL FIELD

The present disclosure relates to a measurement device and a measurement method, in particular a measurement device configured for interacting with an optical fiber element incorporating an array of fiber Bragg gratings, FBGs, to measure a local parameter at a sensing location associated with any one of said FBGs and a measurement method of measuring said local parameter using said measurement device.

### BACKGROUND

In some industrial applications, it is imperative to be able to measure one or more local parameters, such as a local temperature or a local strain, in a reliable manner at various sensing locations. One solution is to arrange an optical fiber element in an arrangement, such as a structure, an apparatus, or a building, which optical fiber element implements an array of fiber Bragg gratings (FBGs) arranged to correspond at respective sensing locations of said arrangement. Each FBG typically reflects one wavelength and allows transmission of all other wavelengths, however, each FBG may be affected by various parameters, such as local temperature and local strain, which consequently shifts the reflecting wavelength of the FBG. By analyzing the reflected response, changes in the local parameter at the different sensing locations may be deduced via spectral analysis.

Most FBG systems today operate in a narrow wavelength range, e.g. the C-band range (˜1530 nm to ˜1575 nm). This sets a limit to the maximum number of sensing locations that can be unequivocally analyzed. Since it is desirable to be able to measure local parameters at many different sensing locations in the same loop of an optical fiber element, the C-band range is quickly occupied.

One solution is to reuse wavelengths, meaning that two identical FBGs are used but located sufficiently far away from each other so they can be separated by timings in a reflected response from light pulses emitted with some repetition rate. This solution however requires a measurement system capable of both performing spectral analysis and being able to distinguish responses from different FBGs via timing measurements. Such conventional systems are typically very complex and costly and ill-suited to be used in the field.

Thus, there is a desire to provide a solution which alleviates or improves at least some aspects of existing solutions.

### SUMMARY

It is an object of the present invention to provide an improved solution that alleviates the mentioned drawbacks of present solutions. A first object of the invention is to provide a measurement device which is capable of providing accurate measurements while being significantly cheaper to manufacture and/or operate as compared to conventional solutions. This object is solved by the invention according to claim 1. A second object of the invention is to provide a measurement device which enables accurate measurement of a local parameter such as local temperature or local strain. This object is also solved by the invention according to claim 1. A third object of the invention is to provide a measurement device capable of distinguishing measurements of local parameters from different sensing locations. This object is also solved by the invention according to claim 1. A fourth object is to measure a local parameter in accordance with the objects specified above. This object is solved by the invention according to claim 14. Preferred embodiments are specified in the dependent claims and further specified in the following.

According to a first aspect of the invention, a measurement device is provided for measuring a local parameter using an optical fiber element incorporating an array of fiber Bragg gratings, FBGs.

The measurement device comprises:
a semiconductor optical amplifier, SOA, comprising: a control input for receiving electrical current pulses to control the repetition rate of said SOA, an optical input for receiving light pulses to be amplified, and an optical output for emitting light pulses;
a pulse generator for providing the control input of the SOA with electrical current pulses to drive the SOA to emit light pulses;
light transmitting means for repeatedly
   transmitting said light pulses from the optical output of the SOA to a FBG array of FBGs, and
   transmitting a fraction of reflected light pulses from each FBG of the FBG array to the optical input of the SOA to form a respective optical cavity with a characteristic lasing wavelength for each FBG of the FBG array;
wherein the measurement device is configured to be able to cause lasing at a respective lasing wavelength of said FBG of the FBG array;
the measurement device further comprising:
   a filter element configured with a wavelength dependent transmission coefficient so that the filter element is able to filter the intensity of light transmitted from the respective optical cavities to output filtered light at a light intensity which is unique over a respective predetermined lasing wavelength range for said one of the FBGs of the FBG array;
   an output light sensing element configured to detect said light intensity of said filtered light from the filter element and emit a corresponding electrical signal;
   processing means for converting the electrical signal to the local parameter being measured for said one of the FBGs of the FBG array, and for providing the local parameter being measured.

Each sensing location may be defined by the position of each FBG of the FBG array. The sensing locations may be moved relative each other by arranging the optical fiber element accordingly. The optical fiber element may be adapted to be arranged in an arrangement, such as a structure, apparatus or building. The optical fiber element may be adapted to be arranged in the ground or in mountains. The optical fiber element may be adapted to be arranged in other applications as well where applicable.

The measurement device may be adapted so as to be able to be optically connected with said optical fiber element. When connected to the optical fiber element, the measurement device is capable of performing measurements of a local parameter at each sensing location.

By this measurement device, accurate measurements of local parameters may be obtained.

The measurement device may be adapted to operate such that the SOA is able to emit light pulses at a repetition rate corresponding to the roundtrip time of light pulses when reflected from one of the FBGs of the FBG array. A portion of the spectra of the light pulses is reflected back to the optical input of the SOA. The SOA may consequently emit light pulses with a light spectrum but amplifying the wavelength region corresponding to the peak region or peak regions of the reflected light spectrum. After passing through the SOA a plurality of times, the output power of light pulses emitted from the SOA becomes mostly associated with, or locked to, the wavelength where most of the light spectrum is reflected by said one of the FBG. This phenomenon is typically referred to as lasing. In this lasing regime, the linewidth of the laser is narrower than the nominal linewidth of the FBG, which improves the spectral resolution of the measurement device and makes the determination of the local parameter much more accurate.

By lasing wavelength, it may be meant the wavelength where lasing occurs for one of the FBGs. Each FBG may be characterized by a unique characteristic lasing wavelength. This characteristic lasing wavelength may be such that it corresponds to the Bragg wavelength of the respective FBG at a particular local temperature, e.g. a nominal local temperature and nominal local strain during intended use. By changes in the local temperature and/or the local strain, the lasing wavelength may be shifted from the characteristic lasing wavelength. Moreover, two or more of the FBGs may have the same characteristic lasing wavelength in which case they may be distinguished from one another by means of how the SOA is gated or by means of the selected repetition rate.

The measurement device may be adapted to emit pulsed light at a repetition rate which leads to lasing to occur with anyone of said FBGs of the FBG array. The SOA may be operated such that it emits light pulses in synchronism with the arrival times of reflected light pulses received in the optical input of the SOA. By synchronism, it may be meant that a subsequent event follows a prior event in a regular and repeating manner, and that there may be a time delay between the two events or that the two events occur virtually simultaneous. As an example, the first event may be the event where reflected light pulses is received at the optical input of the SOA and the second event may be the event where electrical current pulses drive the SOA to emit light pulses.

The measurement device comprises a filter element configured with a wavelength dependent transmission coefficient. By this filter element, the light intensity of light pulses is filtered differently based on the wavelength of the pulsed light, i.e. the lasing wavelength during lasing. The output light sensing element configured to detect said light intensity thus relates lasing wavelengths to amplitudes of the corresponding electrical signal. The lasing wavelength and thus its shift from the characteristic lasing wavelength may be determined from the amplitude or relative amplitude shift in the corresponding electrical signal. Consequently, the local parameter being measured may be determined as well.

As stated, the filter element is able to filter the intensity of light transmitted from the respective optical cavity to output filtered light at a light intensity which is unique over a respective predetermined lasing wavelength range for said one of the FBGs of the FBG array. The respective predetermined lasing wavelength ranges may be completely unique from each other, i.e. they do not overlap. This is the case wherein each FBG is associated with a unique characteristic lasing wavelength. Alternatively, some of the respective predetermined lasing wavelength ranges may overlap or may partly overlap. This is the case wherein at least two of the FBGs are associated with similar characteristic lasing wavelength.

By means of the wavelength dependent transmission coefficient, the filter element is capable of relating lasing wavelength to a filtered light intensity which is detected by the output light sensing element which in turn outputs a corresponding electrical signal. From this electrical signal, a corresponding local parameter associated with the sensing location may be determined. The sensing location, i.e. which FBG is associated with the measured lasing wavelength, may be determined by the manner of how the SOA is gated. Consequently, both position and local parameter may be determined in an accurate and cost-efficient manner, thereby solving the first object of the invention.

Moreover, by means of the filter element, no expensive system (such as spectrometer or spectrum analyzer) as in conventional solutions is required, in order to determine changes in local parameters. The present invention may be adapted in a cost-efficient manner while providing indeed accurate measurements. The invention does not require any complex system for performing spectral analysis as in conventional solutions, hence the invention may be manufactured more cheaply. The invention may also be adapted in a compact form factor due to no longer requiring as many large and complex components as in conventional systems. The invention is also easier to operate since the invention allows easy conversion between lasing wavelength and a corresponding electrical signal which can be analyzed. Thus, the invention solves the first object of the invention. The invention also enables measurement of lasing wavelength and shifts thereof which in turn can be converted into measurements of local parameters. Thus, the invention solves the second object of the invention also.

The invention also enables a plurality of FBGs with the same characteristic lasing wavelength to be distinguished from one another. In effect, this means that measurements can be directly related to a specific sensing location. Thus, the invention also solves the third object of the invention.

By local parameter, it may be meant a measurand impacting an FBG. The measurand may e.g. be strain or temperature.

One or more of the characteristic lasing wavelengths of the FBGs may be within the wavelength range of ˜1530 nm to ˜1575 nm. One ore more of the characteristic lasing wavelengths of the FBGs may be within the wavelength range of 1360 nm-1460 nm, 1460 nm-1530 nm, 1530 nm-1565 nm, 1565 nm-1625 nm, or 1625 nm-1675 nm, or any combined ranges thereof.

The relative shift in the lasing wavelength, Δλₛ/λₛ, due to an applied strain (∈) and a change in temperature (T−T₀) may be approximately given by,

$$[ \frac{{Δλ}_{s}}{{λ}_{s}} ] = ( 1 - {p}_{e} ) ϵ + ( {α}_{Λ} + {α}_{n} ) ( T - {T}_{0} )$$

wherein pₑ is the strain optic coefficient, α_{Λ} is the thermal expansion coefficient, and αₙ is the thermo-optic coefficient. The strain optic coefficient pₑ, the thermal expansion coefficient α_{Λ}, and the thermo-optic coefficient an may be known for the respective FBGs used in the optical fiber element. The characteristic lasing wavelength λₛ of the respective FBGs may also be known for a given reference temperature T₀ when no strain ∈ is applied.

The filter element and the output light sensing element may relate the lasing wavelength, or relative shift thereof, to an amplitude, or a relative amplitude shift, in the electrical signal. Thus, the strain ∈ or the temperature T may be determined based on the amplitude or relative amplitude shift of the electrical signal.

The relative positions of the FBGs in the FBG array may also be known, either via initial measurements or inferred from a known standard of the respective FBGs or FBG array or from otherwise provided information. Consequently, the roundtrip times to the respective FBGs may also be known. The roundtrip times may alternatively be determined based on a frequency sweep of the measurement device to determine at which frequencies lasing occurs together with successively moving a gating window of the measurement device. Thus, two FBGs lasing at the same lasing frequency may be distinguished by means of different timings which may be measured by the measurement device.

Furthermore, optional details of the elements of the measurement device are summarized in the following.

The semiconductor optical amplifier, SOA, may be any suitable SOA. The SOA may have more inputs and/or outputs than the specified control input, optical input and optical output, in order to enable additional functionalities.

The pulse generator may also be any suitable pulse generator. The pulse generator may be adapted to draw power from a power source. The pulse generator may be adapted to be capable of varying the frequency of electrical pulses for driving the SOA.

The light transmitting means may be adapted to optically connect the optical output of the SOA, the optical input of the SOA, and, during use, the optical fiber element incorporating the FBG array. Thus, one or more optical cavities may be formed during use depending on the number of FBGs of the FBG array in the connected optical fiber element. The light transmitting means may also be adapted to optically connect a point between the optical input and optical output of the SOA to the filter element and the output light sensing element. The light transmitting means may comprise one or more optical fiber element. The light transmitting means may comprise one or more couplers. The light transmitting means may comprise one or more circulators. Any coupler or circulator may be arranged to optically connect two or more optical fiber elements.

The filter element may be configured with a wavelength dependent transmission coefficient. The filter element may comprise one or more FBG elements arranged to filter the intensity of light pulses from the respective optical cavity based on lasing wavelength.

The output light sensing element may be adapted to detect light intensity and emit a corresponding signal. The amplitude of the corresponding electrical signal may depend on intensity of detected light intensity. The output light sensing element may be a photodiode element.

The processing means for converting the electrical signal to the local parameter being measured for said one of the FBGs of the FBG array may be a CPU. The CPU may be internally arranged in the measurement device. The processing means may be a server which is adapted to process measurements remotely. The processing means may be adapted to draw power from an internal battery or to draw power from an external power source. The measurement device may comprise electronics for enabling wireless communication.

According to one embodiment, the measurement device is configured to determine roundtrip times of light pulses emitted from the SOA and corresponding reflected light pulses received by the SOA based on the resonant frequencies of the pulse generator for the respective lasing wavelength. Alternatively, or in combination, it may be determined based on the characteristic lasing wavelength or the lasing wavelength. Alternatively, or in combination, it may be determined based on the repetition rate that leads to lasing. Alternatively, or in combination, it may be based on timings of the emitted light pulses from the optical output of the SOA and timings of whenever reflected light pulses are received at the optical input of the SOA. By this, the roundtrip times may be measured and the measurement device may be calibrated thereafter. The repetition rate may be such that an emitted light pulse is reflected back from one particular FBG of the FBG array to the SOA before the next light pulse is emitted. Thus, the repetition rate is correlated with the roundtrip time to that particular FBG. The roundtrip time may then be determined as the reciprocal of the repetition rate. The distance may then be approximated as the speed of light when travelling through fiber optics times the roundtrip time divided by two. The speed of light when travelling through fiber optics may be the speed of light in vacuum, c, divided by the refractive index of the fiber optics. For conventional fiber optics, the refractive index may be approximately 1.46. The true distance may be calibrated to compensate for the extra distance traveled within the measurement device so that the true distance to a sensing location is measurement from another point of reference as desired, e.g. from an outside surface of the measurement device.

According to one embodiment, said output light sensing element is a first light sensing element, wherein the measurement device further comprises a second light sensing element configured to detect the intensity of the lasing wavelength. By means of a second light sensing element, the light intensity before being filtered by the filter element may be determined rather than being inferred by the input power and estimated losses within the measurement device. The corresponding electrical signal may be normalized based on a corresponding electrical signal outputted from the second light sensing element. This may allow for accurate measurements to still be determined, even if the SOA experiences reduced input power for any reason, for instance if the measurement device is adapted to draw power from a battery and the battery is running out of power available.

According to one embodiment, the filter element is a fiber-based Fabry-Perot etalon or an anodized FBG and/or the optical cavity is a sigma-shaped optical cavity.

By fiber-based Fabry-Perot etalon, it may mean that the filter element comprises an optical cavity made from two parallel reflecting surfaces such as thin mirrors. This may result in that optical waves can pass through the optical cavity only when they are in resonance with it. The filter element may comprise a plurality of such optical cavities made from a respective set of two parallel reflecting surfaces. Alternatively, or in combination, the filter element may be adaptive so that the distance between the two reflecting surfaces is adjustable to different positions corresponding to different optical cavities. Each cavity may correspond to a respective characteristic lasing wavelength. When the lasing wavelength deviates from a characteristic lasing wavelength, the intensity of reflected light is reduced in a proportional manner. This may then allow for this deviation to be quantified so that the local parameter may be measured.

Alternatively, the filter element may be an apodized FBG.

The optical cavity may be a sigma-shaped optical cavity. The optical cavity may have other appropriate shapes as applicable.

According to one embodiment, said filter element is configured so that, for any one of, or for each of, the respective predetermined lasing wavelength ranges, the relationship between the light intensity of filtered light and lasing wavelength is such that the light intensity is increasing for increasing lasing wavelengths or such that the light intensity is decreasing for increasing lasing wavelengths. Thus, the filter element is able to, for any of the respective predetermined lasing wavelength ranges, to filter intensity of light pulses such that the intensity of light is either increasing or decreasing. This may result in a one-to-one correlation between a lasing wavelength and an amplitude of the corresponding electrical signal. Each of the respective predetermined lasing wavelength ranges may be comprised in a non-overlapping manner in an overarching lasing wavelength range. The filter element may be adapted to filter light pulses such that the intensity of light is either increasing or decreasing for the whole overarching lasing wavelength range. The overarching lasing wavelength range may be selected such that it comprises all characteristic lasing wavelengths required by the optical filter element being subjected to measurements. The filter element may be configured with a wavelength dependent transmission coefficient which exhibits a sinusoidal behavior of light intensity filtered with respect to wavelength. Respective predetermined lasing wavelengths may thus be selected as regions of any of the peak-to-peak regions of the sinusoidal filtering, preferably regions which can be approximated as linearly increasing or decreasing.

The relationship between the light intensity of filtered light and lasing wavelength is such that the light intensity is increasing for increasing lasing wavelengths or such that the light intensity is decreasing for increasing lasing wavelengths. The light intensity may be monotonously or linearly increasing or decreasing for any of, or all of, the respective predetermined lasing wavelength ranges or for the overarching lasing wavelength range as a whole. The light intensity may be exponentially increasing or decreasing for any of, or all of, the respective predetermined lasing wavelength ranges or for the overarching lasing wavelength range as a whole.

According to one embodiment, the measurement device further comprises a variable optical attenuator to attenuate the lasing wavelength. The variable optical attenuator may be optically connected between the optical output of the SOA and the optical input of the SOA. By the variable optical attenuator, a threshold of output power may be determined. This may allow it to be determined when the gain of the SOA is able to overcome output power losses associated with the light transmitting means or the FBGs of the FBG array. The threshold may be selected so as to determine whenever the SOA is operating in a lasing regime. The measurement device may comprise means to obtain information whenever the output power of the SOA exceeds the threshold of output power. The measurement device may be adapted to provide measurements of local parameters only when the SOA is operating in the lasing regime. The measurement device may be adapted to indicate when the SOA is operating in the lasing regime. Said indication may be displayed on a displaying means. Alternatively, or in combination, the measurement device may be adapted to indicate when the SOA is not operating in the lasing regime, which indication may be displayed on a displaying means.

According to one embodiment, said SOA is a first SOA, and wherein the measurement device further comprises at least a second optical amplifier arranged in an optical loop with the first SOA. By having a second optical amplifier arranged in this manner, a greater optical gain may be achieved. By arranged in an optical loop, it may be meant that the optical output of the first SOA is optically connected to an optical input of the second optical amplifier and an optical output of the second optical amplifier is optically connected to the optical input of the first SOA. The second optical amplifier may be any other suitable optical amplifier. For instance, the second optical amplifier may be an Erbium doped fiber amplifier, EDFA. By using an EDFA operated continuously in time, only the first SOA would be gated, thus defining the roundtrip time. The second optical amplifier may also be a second SOA.

By optical connected, it may mean that any two components optically connected to one another are directly optically connected to each other or indirectly optically connected to one another. By indirectly optically connected to another, it may be meant that between any two components being optically connected to one another, there may be a third component in the optical path between the two components and light passes through said third component. By directly optically connected to one another, it may be meant that there is no third component between any two components being optically connected to one another.

The second optical amplifier may have similar inputs and outputs as the first SOA. Additionally or alternatively, the second optical amplifier may have similar input contact(s) and output contact(s) as the first SOA.

The second optical amplifier may be of an identical model as the first SOA.

The second optical amplifier may be of a different model as the first SOA.

The second optical amplifier may be an Erbium doped fiber amplifier, EDFA, or a second SOA.

The second amplifier may be optically connected in such a way as to amplify the light emitted from the first SOA at least once, before this light is reinjected at the input of the first amplifier.

According to one embodiment, the optical output of the first SOA is optically connected to an optical input of the second optical amplifier and an optical output of the second optical amplifier is optically connected to an optical input of the first SOA. When the first SOA emits light pulses to an FBG array of FBGs, at least some of the light is then reflected back from any of these FBGs to the optical input of the second optical amplifier. The second optical amplifier then may provide an optical gain at the lasing wavelength for any of the FBGs in the FBG array. The optical output of the first SOA may be optically connected to an optical input of the second optical amplifier via the FBG array. An optical output of the second optical amplifier may be optically connected to an optical input of the first SOA.

According to one embodiment, the second optical amplifier is configured for increasing the optical gain at the lasing wavelength.

According to one embodiment, the fiber element is arranged on one side of the fiber coupler and the output light sensing element configured to measure the filtered light from the fiber element. The fiber element may be arranged between the fiber coupler and the output light sensing element configured to measure the filtered light from the fiber element.

The filter element may be a multicore fiber element used in transmission. By multicore fiber element, it means a short segment of fiber comprising two or more cores for transmitting light between the ends, where wavelength-dependent optical coupling takes place between cores. By optically connecting only one of the cores of said two or more cores, for instance a central core, the multicore fiber element may filter traveling through the core in terms of wavelength. A multicore fiber may be a twin core, or comprise three, four, five, or more cores. The length of the multicore fiber may have a lower length limit being a fraction of 1 mm. The length of the multicore fiber may have an upper length limit of 10 cm. The length of the multicore fiber element may be in the interval of 0.01 mm-0.1 mm, 0.1 mm-1 mm, 1 mm-1 cm, 1 cm-20 cm, or in the interval of any combination of said intervals.

One end of the core may be optically connected to a fiber coupler. One other end of the core may be optically connected to the output light sensing element.

According to one embodiment, the light transmitting means comprises optical fiber and one or more of a fiber coupler and/or one or more of a fiber circulator. By this, the various components may be optically connected accordingly.

Between the optical output of the first SOA and the optical input of the first SOA, a coupler or a circulator may be optically connected. Said coupler or circulator may be adapted to enable light pulses to travel from the optical output of the first SOA to the FBGs of the FBG array. Said coupler or circulator may be adapted to enable reflected light pulses to travel from the FBGs of the FBG array to the optical input of the first SOA. In case a second optical amplifier is present, the coupler or circulator may be adapted to enable reflected light pulses to travel from the FBGs of the FBG array to the optical input of the second optical amplifier. If a variable optical attenuator is present, the coupler or circulator may be adapted to enable reflected light pulses to travel from the FBGs of the FBG array to the variable optical attenuator before reaching the optical input of the first SOA. If both a variable optical attenuator and a second optical amplifier is present, the variable optical attenuator may be optically connected to the optical output of the second optical amplifier or between the coupler or circulator and the optical input of the second optical amplifier.

The measurement device may comprise more than one coupler or circulator, e.g. the measurement device may comprise a first coupler or circulator and a second coupler or circulator. The first coupler or circulator may correspond to the coupler or circulator optically connected to the optical output of the first SOA. The second coupler or circulator may be arranged optically connected between the first coupler or circulator and the optical input of the first SOA. The second coupler or circulator may be adapted to enable a fraction of light to travel to the filter element and the output light sensing element.

The measurement device may comprise an optical connection means for optically connecting with the optical fiber element incorporating the FBG array.

The light transmitting means may comprise a set of optical fiber elements for optically connecting the various components of the measurement device.

According to one embodiment, the second optical amplifier is arranged between a first fiber coupler and a second fiber coupler. Alternatively, the second optical amplifier is arranged between the optical input of the first SOA and the first and/or second fiber coupler. The second optical amplifier may be arranged between the optical output of the first SOA and the first fiber coupler. The second amplifier may be arranged between the first fiber coupler and the FBG array.

According to one embodiment, the measurement device further comprises selection means for calibrating the measurement device to measure a selected local parameter. By this, a user may operate the measurement device in order to select one local parameter to be measured. The measurement device may be adapted to enable selection between local temperature or local strain. The measurement device may be adapted to enable selection of other local parameters as well, such as local vibration. The selection means may for instance comprise a physical button, a touch interface, or a turn knob.

According to one embodiment, the measurement device further comprises sample-and-hold circuitry down-stream of said light sensing element. The sample-and-hold circuitry may enable a measurement of a local parameter to be displayed for a time period much longer than the duration of light pulses of the first SOA. This may facilitate the local parameter to be sampled and processed elsewhere or it may facilitate readings of the local parameter if displayed on a displaying means.

According to one embodiment, the measurement device further comprises displaying means for displaying a measured local parameter. The displaying means may be a display. The displaying means may be a touch display. The displaying means may be adapted to display other parameters of the measurement device as well. The displaying means may be adapted to display a duration of measurements, whether or not the device is operating in the lasing regime, battery level if a battery is present, the number of sensing locations identified, which local parameter is selected to be displayed, and/or other appropriate parameters.

According to one embodiment, the measurement device further comprises a battery. By this, the measurement device may be more portable or completely wireless. Alternatively, the measurement device is wired to a power source by means of an electrical cord of sufficient length that enables mobility of the measurement device.

According to one embodiment, the measurement device further comprises a housing adapted in shape and size to enable hand-held use. The measurement device may be adapted in a portable form factor. This may further facilitate measurements of a local parameter on site.

According to a second aspect, a method of measuring a local parameter of an optical fiber element incorporating an array of fiber Bragg gratings, FBGs, wherein each FBG of the FBG array is located at a predetermined sensing location, is provided. The method comprises: a step of providing a measurement device according to the first aspect or any embodiments thereof; a step of optically connecting said optical fiber element to the light transmitting means of the measurement device; a step providing electrical current pulses to the control input of said SOA; a step of measuring the local parameter using said measurement device, a step of receiving the local parameter being measured from said measurement device, and a step of displaying the measured local parameter on a displaying means.

By this method, one or more local parameters may be measured in an accurate and cost-efficient manner. Thereby, this method solves the fourth object of the invention specified above.

The method may comprise additional method steps and/or details thereof which are disclosed in association with the summary of the measurement device above.

According to one embodiment, the information of roundtrip times is determined based on the resonant frequencies of the pulse generator for the lasing wavelength. By this, the method does not require predetermined information about how the FBGs of the FBG array of the optical fiber element are arranged. This has the advantage of

The invention is defined by the appended independent claims, with embodiments being set forth in the appended dependent claims, in the following description and in the drawings.

### BRIEF DESCRIPTION OF THE DRAWINGS

The invention will in the following be described in more detail with reference to the enclosed drawings, wherein:

FIG. 1 shows a schematic illustration of a measurement device according to one embodiment of the invention;

FIG. 2 shows a schematic illustration of a measurement device according to one embodiment of the invention;

FIG. 3 shows a schematic illustration of a measurement device according to one embodiment of the invention;

FIG. 4 shows a schematic illustration of a measurement device according to one embodiment of the invention;

FIG. 5 shows a schematic illustration of a measurement device according to one embodiment of the invention;

FIG. 6 illustrates an embodiment of a method of measuring a local parameter of an optical fiber element incorporating an array of fiber Bragg gratings, FBGs, using a measurement device according to one embodiment of the invention;

FIG. 7 illustrates a graph showing the filtering behavior provided by the filter element according to one embodiment of the invention;

FIG. 8 shows a plurality of measurements of a local parameter by means of the measurement device and method according to one embodiment of the invention;

FIG. 9 shows a schematic illustration of a measurement device according to one embodiment of the invention.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

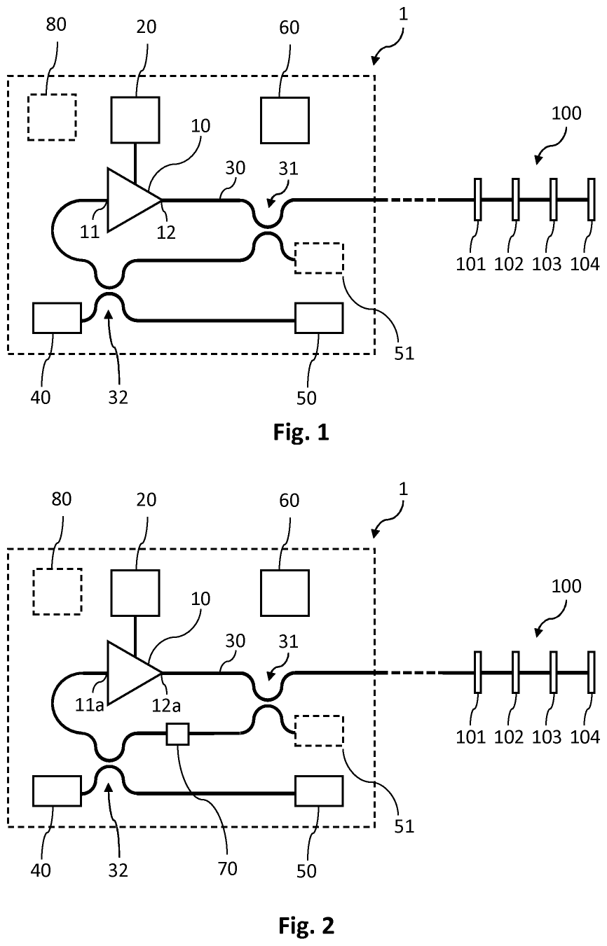

FIG. 1 shows a schematic illustration of a measurement device 1 according to one embodiment of the invention. The measurement device 1 is adapted for being able to measure a local parameter using an optical fiber element incorporating an array 100 of fiber Bragg gratings, FBGs, 101, 102, 103, 104. The optical fiber element 100 may be arranged in an arrangement, such as a structure, an apparatus or a building, wherein the positions of the FBGs 101, 102, 103, 104 define a set of sensing locations. The measurement device 1 is adapted to be able to optically connect with said optical fiber element 100 and perform measurements to measure a lasing wavelength associated with any one of said FBGs 101, 102, 103, 104. The measurement device 1 is adapted to be able to subject the FBGs 101, 102, 103, 104 to pulsed light in a lasing regime.

The measurement device 1 comprises a semiconductor optical amplifier, SOA, 10. The SOA 10 comprises a control input for receiving electrical current pulses to control a repetition rate of said SOA 10. The SOA 10 further comprises an optical input 11 for receiving light pulses to be amplified and an optical output 12 for emitting light pulses. The measurement device 1 further comprises a pulse generator 20 for providing the control input of the SOA 10 with electrical current pulses to drive the SOA to emit light pulses. The measurement device 1 further comprises light transmitting means 30, 31, 32 for repeatedly transmitting said light pulses from the optical output 12 of the SOA to a FBG array 100 of FBGs 101, 102, 103, 104, and transmitting a fraction of reflected light pulses from each FBG of the FBG array 100 to the optical input of the SOA 10 to form a respective optical cavity with a characteristic lasing wavelength for each FBG of the FBG array.

The measurement device 1 further comprises a filter element 40 configured with a wavelength dependent transmission coefficient so that the filter element 40 is able to filter the intensity of light transmitted from the respective optical cavity to output filtered light at a light intensity which is unique over a respective predetermined lasing wavelength range for said one of the FBGs 101, 102, 103, 104 of the FBG array. The measurement device 1 further comprises an output light sensing element 50 configured to detect said light intensity of said filtered light from the filter element 40 and emit a corresponding electrical signal. The measurement device 1 further comprises processing means 60 for converting the electrical signal to the local parameter being measured for said one of the FBGs 101, 102, 103, 104 of the FBG array 100, and for providing the local parameter being measured.

The light transmitting means 30, 31, 32 may comprise optical fiber 30 and one or more of a fiber coupler 31, 32 and/or one or more of a fiber circulator 31, 32. In FIG. 1, the measurement device 1 is exemplified with two couplers 31, 32. The first coupler 31 is optically connected between the optical output 12 of the SOA 10 and the optical input 11 of the SOA 10. Moreover, the coupler 31 is adapted to be optically connected between the optical output 12 of the SOA 10 and the FBG array 100 when the measurement device 1 is optically connected thereto. The second coupler 32 is optically connected between the first coupler 31 and the optical input 11 of the SOA 10. Moreover, the second coupler 32 is optically connected to the filter element 40. The first coupler 31 and the second coupler 32 may each be adapted to be able to transmit a fraction of light pulses between the different paths. Optical fiber 30 may be used to optically connect the various components of the measurement device 1.

Thus, by this device, the measurement device 1 may be operated so as to measure lasing wavelengths or lasing wavelength shifts associated with one of said FBGs 101, 102, 103, 104 and during the lasing regime the filter element 40 may filter the intensity of light from the respective optical cavity so that lasing wavelength or shifts thereof may be one-to-one correlated with an amplitude or an amplitude shift thereof in the corresponding electrical signal. By analyzing the amplitude of the corresponding electrical signal, the local parameter being measured may be determined.

The measurement device 1 may comprise two output light sensing elements 50, wherein the first output light sensing element 50 is arranged to detect filtered light intensity from the filter element 40, and wherein the second output light sensing element 51 is arranged to measure light intensity of light pulses from the first coupler 31 and output a corresponding electrical signal also. This corresponding electrical signal may be used to normalize the corresponding electrical signal from the first output light sensing element 50. This may be advantageous for instance when the SOA 10 for any reason is not provided with sufficient power which then consequently may impact the light intensity detected from the filter element 40.

The local parameter being measured may be a local temperature or a local strain. The local parameter may be a local vibration.

The measurement device 1 may be configured to determine roundtrip times of light pulses emitted from the SOA and corresponding reflected light pulses received by the SOA based on the resonant frequencies of the pulse generator for the respective lasing wavelength.

Moreover, the measurement device 1 may comprise a batter 80 adapted to supply power to one or more of the components of the measurement device 1, such as the SOA 10 and the pulse generator 20.

FIG. 2 shows a schematic illustration of a measurement device 1 according to one embodiment of the invention. In this exemplified embodiment, the measurement device 1 comprises a variable optical attenuator 70. The variable optical attenuator 70 is optically connected between the first coupler 31 and the second coupler 32. By means of the variable optical attenuator, a threshold of output power from the SOA may be determined which may allow it to be determined when the gain of the SIA is able to overcome output power losses associated with the light transmitting means 30, 31, 32 or the FBGs 101, 102, 103, 104 of the FBG array 100.

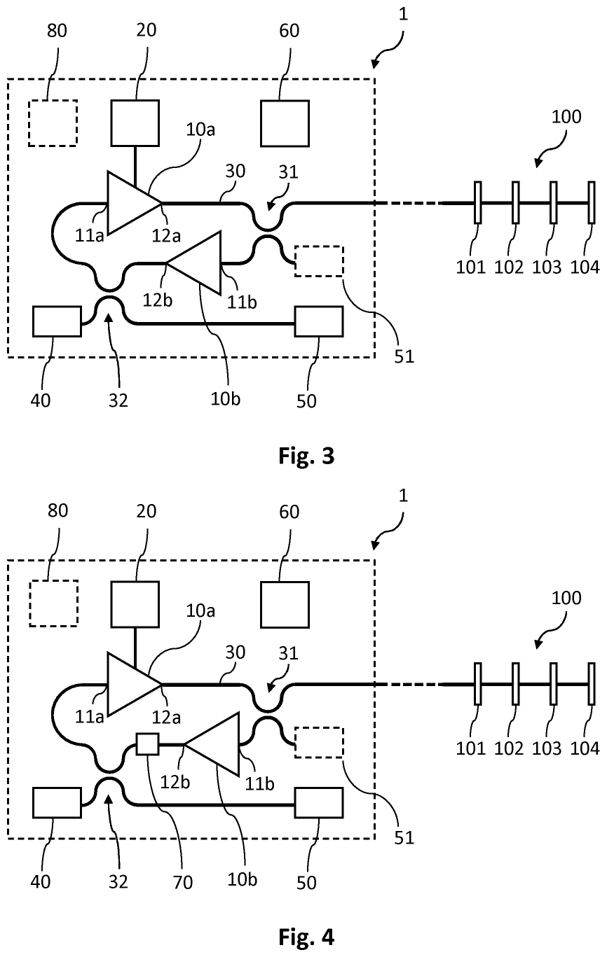

FIG. 3 shows a schematic illustration of a measurement device 1 according to one embodiment of the invention. In this exemplified embodiment, the measurement device 1 comprises a second optical amplifier 10b in combination with said SOA, i.e. the first SOA 10a. The second optical amplifier 10b is arranged so that the optical input 11b is optically connected with the first coupler 31 and the optical output 12b is optically connected with the optical input 11a of the first SOA 10a. By having a second optical amplifier 10b arranged in this manner, a greater optical gain may be achieved. The second optical amplifier 10b may be an Erbium doped fiber amplifier, EDFA, or a second SOA.

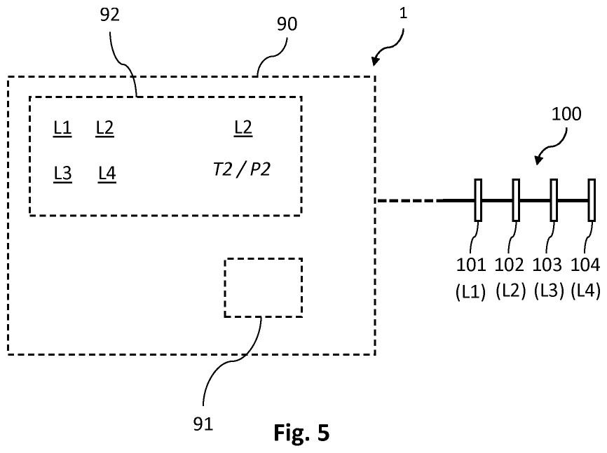

FIG. 4 shows a schematic illustration of a measurement device 1 according to one embodiment of the invention. In this exemplified embodiment, the measurement device 1 comprises both a variable optical attenuator 70 and a second optical amplifier 10b. The second optical amplifier 10b is arranged so that the optical input 11b is optically connected with the first coupler 31 and the optical output 12b is optically connected with the variable optical attenuator 70. The variable optical attenuator 70 is optically connected with the optical input of the first SOA 10.

FIG. 5 shows a schematic illustration of the measurement device 1 according to one embodiment. The measurement device 1 comprises a housing 90. The housing 90 is adapted to provide housing for one or a plurality or all of the components of the measurement device 1. The measurement device 1 may further comprise displaying means 92 for displaying a measured local parameter. The displaying means 92 may be adapted to display more than the measured local parameters, for instance available sensing locations L1, L2, L3, L4 associated with each FBG 101, 102, 103, 104 of the FBG array 100 of the optical fiber element. The measurement device 1 may further comprise selection means 91 for selecting the local parameter to be measured or being measured. The measurement device 1 may further comprise sample-and-hold circuitry for enabling measured parameters to be displayed in a more easily readable manner.

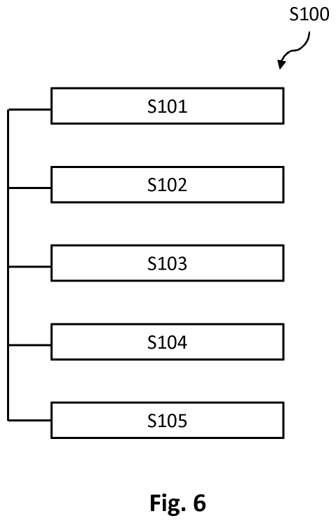

FIG. 6 illustrates an embodiment of a method of measuring a local parameter of an optical fiber element incorporating an array 100 of fiber Bragg gratings, FBGs, 101, 102, 103, 104 using a measurement device 1 according to one embodiment of the invention.

The method S100 comprises: a step S1 of providing a measurement device 1 as herein disclosed; a step S2 of optically connecting said optical fiber element to the light transmitting means of the measurement device; a step S3 of providing electrical current pulses to the control input of said SOA; a step S4 of measuring the local parameter using said measurement device; a step S5 of receiving the local parameter being measured from said measurement device 1, and a step S6 of displaying the measured local parameter on a displaying means.

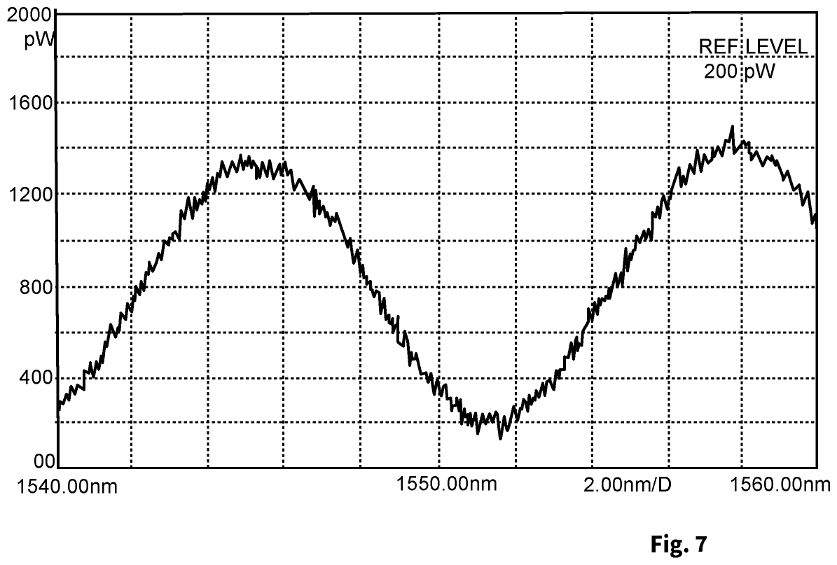

FIG. 7 illustrates a graph showing the filtering behavior provided by the filter element 40 according to one embodiment of the invention. The filter element 40 is configured with a wavelength dependent transmission coefficient exhibiting a sinusoidal filtering behavior. The vertical axis shows the intensity in pW with a reference level of 200 pW and the horizontal axis shows the wavelength. For instance, the one of the respective predetermined lasing wavelength ranges may be selected as a monotonously decreasing range or a monotonously increasing range. Preferably, the respective predetermined lasing wavelength ranges may be selected as the range portions which may be approximated as virtually linearly increasing or decreasing ranges.

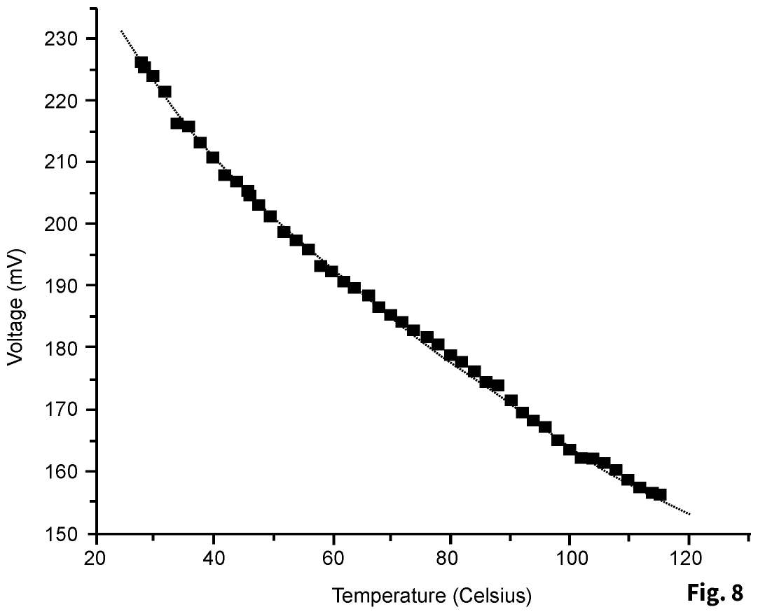

FIG. 8 shows a plurality of measurements of a local parameter by means of the measurement device and method according to one embodiment of the invention. In particular, FIG. 8 relates a voltage amplitude of the corresponding electrical signal outputted by the output light sensing element to a corresponding local temperature in degrees Celsius. For example, when a voltage amplitude of 200 mV is measured, the measurement device 1 may convert this into a corresponding temperature of ˜50° C. If the measurement device 1 is configured to measure a strain instead, then a voltage amplitude of the corresponding electrical signal outputted by the output light sensing element may be related to a corresponding local strain instead.

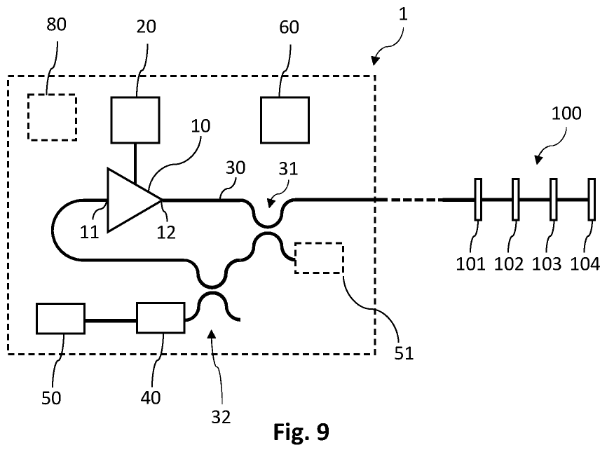

FIG. 9 shows a schematic illustration of a measurement device according to one embodiment of the invention. In this embodiment, the filter element 40 is arranged between the fiber coupler 32 and the output light sensing element 50. The filter element 40 may be a multicore fiber element. By multicore fiber element, it may be meant a fiber element comprising two or more cores for transmitting light between the ends. The fiber element may be adapted so that wavelength-dependent optical coupling takes place between cores. By optically connecting only one of the cores of said two or more cores, for instance a central core, the multicore fiber element may filter traveling through the core in terms of wavelength. A multicore fiber may be a twin core, or comprise three, four, five, or more cores. The length of the multicore fiber may have a lower length limit being a fraction of 1 mm. The length of the multicore fiber may have an upper length limit of 10 cm. The length of the multicore fiber element may be in the interval of 0.01 mm-0.1 mm, 0.1 mm-1 mm, 1 mm-1 cm, 1 cm-20 cm, or in the interval of any combination of said intervals.

One end of the core may be optically connected to a fiber coupler 32. One other end of the core of the multicore fiber element 40 may be optically connected to the output light sensing element 50. By this configuration, it is possible to obtain measurements similar to the measurements obtained by the embodiment illustrated in FIG. 1.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A measurement device for measuring a local parameter using an optical fiber element incorporating an array of fiber Bragg gratings, FBGs, the measurement device comprising:
a semiconductor optical amplifier, SOA, comprising a control input for receiving electrical current pulses to control the repetition rate of said SOA, an optical input for receiving light pulses to be amplified and an optical output for emitting light pulses;
a pulse generator for providing the control input of the SOA with electrical current pulses to drive the SOA to emit light pulses; and
light transmitting means for repeatedly:
transmitting said light pulses from the optical output of the SOA to a FBG array of FBGs, and
transmitting a fraction of reflected light pulses from each FBG of the FBG array to the optical input of the SOA to form a respective optical cavity with a characteristic lasing wavelength for each FBG of the FBG array;
wherein the measurement device is configured to be able to cause lasing at a respective lasing wavelength of said FBG of the FBG array, and
wherein the measurement device further comprises:
a filter element configured with a wavelength dependent transmission coefficient so that the filter element is able to filter the intensity of light transmitted from the respective optical cavity to output filtered light at a light intensity which is unique over a respective predetermined lasing wavelength range for said one of the FBGs of the FBG array;
an output light sensing element configured to detect said light intensity of said filtered light from the filter element and emit a corresponding electrical signal; and
processing means for converting the electrical signal to the local parameter being measured for said one of the FBGs of the FBG array, and for providing the local parameter being measured.

2. The measurement device according to claim 1, configured to determine roundtrip times of light pulses emitted from the SOA and corresponding reflected light pulses received by the SOA based on the resonant frequencies of the pulse generator for the respective lasing wavelength.

3. The measurement device according to claim 1, wherein said light sensing element is a first light sensing element, and wherein the measurement device further comprises a second light sensing element configured to detect the intensity of the lasing wavelength.

4. The measurement device according to claim 1, wherein the filter element is a fiber-based Fabry-Perot etalon or an apodized FBG and/or the optical cavity is a sigma-shaped optical cavity.

5. The measurement device according to claim 1, wherein said filter element is configured so that, for any one of, or for each of, the respective predetermined lasing wavelength ranges, the relationship between the light intensity of filtered light and lasing wavelength is such that the light intensity is increasing for increasing lasing wavelengths or such that the light intensity is decreasing for increasing lasing wavelengths.

6. The measurement device according to claim 1, further comprising a variable optical attenuator for attenuating the lasing wavelength.

7. The measurement device according to claim 1, wherein said SOA is a first SOA, wherein the measurement device further comprises at least a second optical amplifier arranged in an optical loop with the first SOA, and wherein the second optical amplifier is preferably an Erbium doped fiber amplifier, EDFA, or a second SOA.

8. The measurement device according to claim 7, wherein the light transmitting means are further adapted for repeatedly transmitting a fraction of reflected light pulses from each FBG of the FBG array to the optical input of the second optical amplifier and for repeatedly transmitting light pulses from the optical output of the second amplifier to the optical input of the first SOA.

9. The measurement device according to claim 7, wherein the second optical amplifier is configured for increasing the optical gain at the lasing wavelength.

10. The measurement device according to claim 1, wherein the light transmitting means comprises optical fiber and one or more of a fiber coupler and/or one or more of a fiber circulator.

11. The measurement device according to claim 7, wherein the light transmitting means comprises optical fiber and one or more of a fiber coupler and/or one or more of a fiber circulator, and wherein the second optical amplifier is arranged between a first fiber coupler and a second fiber coupler.

12. The measurement device according to claim 1, further comprising selection means for calibrating the measurement device to measure a selected local parameter.

13. The measurement device according to claim 1, further comprising sample-and-hold circuitry down-stream of said light sensing element.

14. The measurement device according to claim 1, further comprising displaying means for displaying a measured local parameter.

15. The measurement device according to claim 1, further comprising a battery.

16. The measurement device according to claim 1, further comprising a housing adapted in shape and size to enable hand-held use.

17. A method of measuring a local parameter of an optical fiber element incorporating an array of fiber Bragg gratings, FBGs, wherein each FBG of the FBG array is located at a predetermined sensing location, the method comprising:
a step of providing a measurement device according to claim 1;
a step of optically connecting said optical fiber element to the light transmitting means of the measurement device;
a step of providing electrical current pulses to the control input of said SOA;
a step of measuring the local parameter using said measurement device;
a step of receiving the local parameter being measured from said measurement device; and
a step of displaying the measured local parameter on a displaying means.

18. The method according to claim 17, wherein the information of roundtrip times is determined based on the resonant frequencies of the pulse generator for the lasing wavelength.
